(19) United States
(12) Patent Application Publication
(10) Pub. No.: US 2021/0007333 A1
(43) Pub. Date: Jan. 14, 2021

(54) MOVABLE AQUACULTURE PLATFORM SUITABLE FOR OFFSHORE ONBOARD CABIN CULTURE AND OPEN CULTURE

(71) Applicant: Fishery Machinery and Instrument Research Institute, Chinese Academy of Fishery Sciences, Shanghai (CN)

(72) Inventors: Mingchao Cui, Shanghai (CN); Hao Xu, Shanghai (CN); Zhixin Chen, Shanghai (CN); Jing Wang, Shanghai (CN)

(73) Assignee: Fishery Machinery and Instrument Research Institute, Chinese Academy of Fishery Sciences, Shanghai (CN)

(21) Appl. No.: 16/885,953

(22) Filed: May 28, 2020

(30) Foreign Application Priority Data
Jul. 12, 2019 (CN) 201910629115.X

(51) Int. Cl. A01K 61/60; B63B 35/26; A01K 63/04

(52) U.S. Cl. CPC A01K 61/60; A01K 63/047; B63B 35/26

(57) ABSTRACT

The present invention relates to a movable aquaculture platform suitable for offshore onboard cabin culture and open culture. The aquaculture platform includes a hull with a propulsion system and an onboard control system. A recess recessed downwards based on a plane of a main deck is provided between the front and rear of the hull. Both sides of the recess are formed into an open structure corresponding to double sides of the hull. The recess is provided with a closed cage. The cage and the recess together constitute an open culture cabin. An internal space of the cage is used for culture. The hull is provided with a closed culture cabin below the recess. The present invention can flexibly switch between an onboard closed cabin culture mode, an onboard open cage culture mode and a mixed mode thereof according to different working conditions.

### TECHNICAL FIELD

The present invention relates to the technical field of ship engineering and aquaculture, and in particular to a movable aquaculture platform suitable for offshore onboard cabin culture and open culture.

### BACKGROUND

Since the 1980s, some developed countries have begun to explore and apply offshore aquaculture techniques. In 1986, the open sea cage (Bridgestone cage) was successfully applied. In 1990, the semi-submersible offshore cage of Sweden FarmOcea was successfully applied. In 1995, “offshore aquaculture” was recognized as a potential fishery growth mode by the Office of Technology Assessment (OTA) of the United States. In 2010, the Food and Agriculture Organization (FAO) proposed that the effective sea area suitable for deep water cage culture reached 189,468 square kilometers. A series of explorations were also carried out in the construction of large-scale offshore aquaculture platforms. For example, France and Norway cooperated to build a 270-meter-long fish farming ship; the Scientific, Technical and Economic Committee for Fisheries (STECF) built a semi-submersible aquaculture ship; Spain conceived a tuna farming ship; Turkey transformed an old ship into an aquaculture ship, and conducted rainbow trout farming experiments; Japan built the “Nagasaki Blue Ocean” aquaculture ship, etc. The “innovation development permit” policy implemented by Norway has further promoted the development of offshore aquaculture. At present, the latest large-scale offshore culture facilities include “Ocean Farm 1”, “Hex Box Cage”, “Ocean Globe” and “Havfarm Aquaculture Ship”. Among them, the “Ocean Farm 1” was a 250,000 cubic meter offshore steel cage developed and built by SalMar. This cage adopted fully automated control and full process information management. It was completed by China Shipbuilding Industry Cooperation (CSIC) through international cooperation in 2017 and has been put into trial run. It is of great significance to carry out onboard closed cabin culture, onboard open cage culture and mixed culture thereof to promote the development of offshore aquaculture industry and improve economic benefits.

### SUMMARY

An objective of the present invention is to provide a movable aquaculture platform suitable for offshore onboard cage culture and open culture. The present invention flexibly switches between an onboard closed cabin culture mode, an onboard open cage culture mode and a mixed mode thereof according to different working conditions.

To achieve the above purpose, the present invention provides a movable aquaculture platform suitable for offshore onboard cabin culture and open culture, including a hull with a propulsion system and an onboard control system, where a recess recessed downwards based on a plane of a main deck is provided between the front and rear of the hull; both sides of the recess are formed into an open structure corresponding to double sides of the hull; the recess is provided with a closed cage having a net structure; the cage and the recess together constitute an open culture cabin; an internal space of the cage is used for culture; the hull is provided with a closed culture cabin below the recess.

Further, at least one upper hatch facing the internal space of the cage is provided on an upper side of the closed culture cabin; each upper hatch is provided with a movable hatch cover for opening and closing; when the hatch cover is opened, an internal chamber of the closed culture cabin communicates with the internal space of the cage through the upper hatch.

Further, the closed culture cabin is provided with at least one water inlet pipe; one end of the water inlet pipe communicates with external water, and the other end of the water inlet pipe communicates with the internal chamber of the closed culture cabin; the water inlet pipe is provided with an inlet side remote valve for opening and closing; the water inlet pipe is provided with a water pump for transporting external water to the internal chamber of the closed culture cabin; the inlet side remote valve and the water pump are controlled by the onboard control system.

Further, the closed culture cabin is provided with at least one overflow pipe; an inlet end of the overflow pipe communicates with the internal chamber of the closed culture cabin, and an outlet end of the overflow pipe is located outside the closed culture cabin; the overflow pipe is provided with an overflow remote valve for opening and closing, and the overflow remote valve is controlled by the onboard control system.

Further, the hull is provided with an oxygen supply device controlled by the onboard control system; an outlet of the oxygen supply device communicates with the internal chamber of the closed culture cabin through an oxygen supply line.

Further, a relative water level above the open culture cabin and below an upper side of the cage is a first water level, and a relative water level below the upper side of the closed culture cabin is a second water level; the outlet end of the overflow pipe is higher than the second water level and lower than the first water level.

The present invention has the following beneficial effects:

1) The present invention flexibly switches between an onboard closed cabin culture mode, an onboard open cage culture mode and a mixed mode thereof according to different working conditions. In use, a hull is driven to sink and float by using a well-known ballast water adjustment method, so as to switch the culture mode. When it is necessary to switch to the mixed culture mode, a hatch cover is opened, so that an internal chamber of a closed culture cabin communicates with an internal space of a cage through an upper hatch, and closed and open culture cabins culture simultaneously. When it is necessary to switch to the onboard open cage culture mode, the hatch cover is closed, so that the closed culture cabin and the cage are isolated from each other, and the culture of fish and other species is restricted to the internal space of the cage. When it is necessary to switch to the onboard closed cabin culture mode, the hull is driven to float, so that the open culture cage is higher than a water surface, and the culture of fish and other species is restricted in the internal chamber of the closed culture cabin for culture.

2) When the closed culture cabin is in use, a water pump is used to charge water into the closed culture cabin, and an overflow pipe is used to discharge water from the closed culture cabin, so as to achieve the purpose of regulating key culture factors such as water temperature and water quality in the closed culture cabin.

3) The present invention effectively reduces the energy consumption of culture, regulates the quality of target culture species, and improves the utilization of equipment space. The hull is equipped with a propulsion system, which helps the hull to effectively avoid a typhoon and ensure the safety of culture.

### BRIEF DESCRIPTION OF DRAWINGS

FIG. 1 shows a vertical section in a first working condition according to the present invention.

FIG. 2 shows a vertical section in a second working condition according to the present invention.

FIG. 3 shows a vertical section in a third working condition according to the present invention.

FIG. 4 is a sectional view taken along line A-A in FIG. 1.

FIG. 5 shows a control relationship according to the present invention.

### REFERENCE NUMERALS

1. hull, 101. main deck, 102. recesses, 103. auxiliary cabin, 104. open culture cabin, 105. cage, 106. hatch cover, 107. closed culture cabin, 107a. upper hatch, 108. water inlet pipe, 109. inlet side remote valve, 110. water pump, 111. overflow pipe, 112. overflow remote valve, 2. propulsion system, 3. first water level, 4. second water level, 5. oxygen supply device, 6. oxygen supply line, and 7. onboard control system.

### DETAILED DESCRIPTION

The present invention is described in more detail below with reference to the accompanying drawings and specific examples.

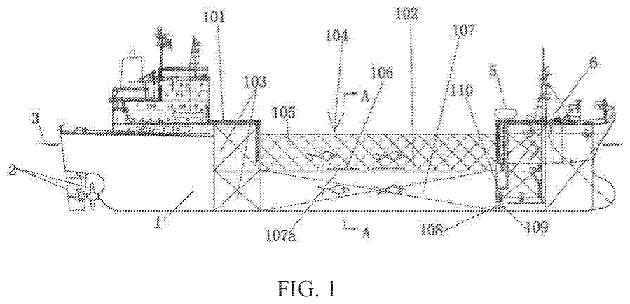

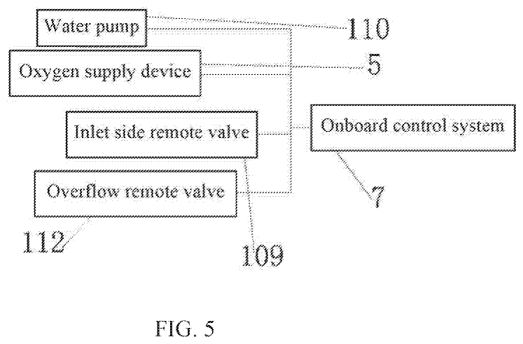

Referring to FIGS. 1 to 5, a movable aquaculture platform suitable for offshore onboard cabin culture and open culture includes a hull 1 with a propulsion system 2 and an onboard control system 7. A recess 102 recessed downwards based on a plane of a main deck 101 is provided between the front and rear of the hull 1. Both sides of the recess 102 are formed into an open structure corresponding to double sides of the hull 1. The recess 102 is provided with a closed cage 105 having a net structure. The cage 105 and the recess 102 together constitute an open culture cabin 104. An internal space of the cage 105 is used for culture. The hull 1 is provided with a closed culture cabin 107 below the recess 102.

At least one upper hatch 107a facing the internal space of the cage 105 is provided on an upper side of the closed culture cabin 107. Each upper hatch 107a is provided with a movable hatch cover 106 for opening and closing. When the hatch cover 106 is opened, the internal chamber of the closed culture cabin 107 communicates with the internal space of the cage 105 through the upper hatch 107a. The hatch cover 106 is automatically opened and closed in various opening and closing modes through remote control.

The closed culture cabin 107 is provided with at least one water inlet pipe 108. That is to say, there is one or more water inlet pipes 108. One end of the water inlet pipe 108 communicates with external water, and the other end of the water inlet pipe 108 communicates with the internal chamber of the closed culture cabin 107. The water inlet pipe 108 is provided with an inlet side remote valve 109 for opening and closing. The water inlet pipe 108 is provided with a water pump 110 for transporting external water to the internal chamber of the closed culture cabin 107. The inlet side remote valve 109 and the water pump 110 are controlled by the onboard control system 7.

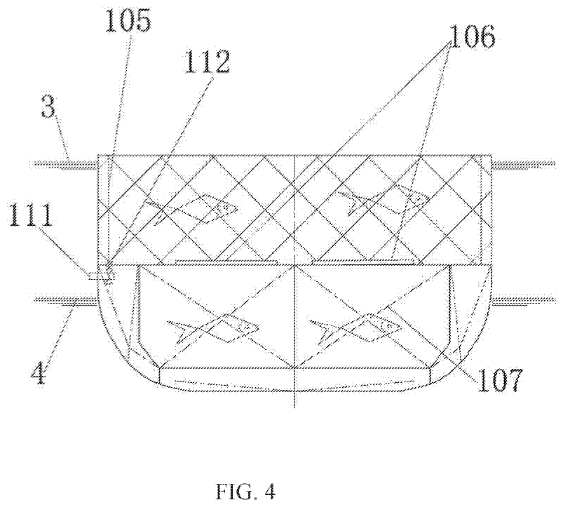

As shown in FIG. 4, the closed culture cabin 107 is provided with at least one overflow pipe 111. An inlet end of the overflow pipe 111 communicates with the internal chamber of the closed culture cabin 107, and an outlet end of the overflow pipe 111 is located outside the closed culture cabin 107. The overflow pipe 111 is provided with an overflow remote valve 112 for opening and closing, and the overflow remote valve 112 is controlled by the onboard control system 7.

The hull 1 is provided with an oxygen supply device 5 controlled by the onboard control system 7. An outlet of the oxygen supply device 5 communicates with the internal chamber of the closed culture cabin 107 through an oxygen supply line 6. When the closed culture cabin 107 is in a culture state, the outlet of the oxygen supply device 5 passes oxygen through the oxygen supply line 6 to the internal chamber of the closed culture cabin 107 to maintain an oxygen content of the aquatic water in the internal chamber of the closed culture cabin 107. The oxygen supply device 5 provides liquid oxygen or oxygen produced by an oxygen generator. It is necessary to provide oxygen according to the requirements of aquaculture, so as to ensure the safety of aquaculture, increase the density of aquaculture, and improve the utilization of equipment.

A relative water level above the open culture cabin 104 and below an upper side of the cage 105 is a first water level 3, and a relative water level below the upper side of the closed culture cabin 107 is a second water level 4. The outlet end of the overflow pipe 111 is higher than the second water level 4 and lower than the first water level 3.

When in use, the aquaculture platform is autonomously navigated by the propulsion system 2 according to the needs of aquaculture, so that the entire platform reaches a target sea area or avoids a typhoon at sea. When in use, the hull 1 is sunk and floated by using a well-known ballast water adjustment method, so as to switch the culture mode. The hull 1 is provided with a special ballast water adjustment system to charge or discharge the ballast water.

As shown in FIG. 1, a mixed culture mode is set as a first working condition. After reaching a target sea area, the hull 1 is at the position of the first water level 3. The hatch covers 106 are all or partially opened, so that the internal chamber of the closed culture cabin 107 communicates with the internal space of the cage 105 through the upper hatch 107a, and the closed culture cabin 107 and the open culture cabin 104 culture simultaneously. It is also possible to close all hatch covers 106, so that the closed culture cabin 107 and the open culture cabin 104 are isolated from each other for independent culture as needed. The water pump 110 is used to pump water into the closed culture cabin 107, and the overflow pipe 111 is used to discharge water outside, so as to achieve the purpose of regulating key culture factors such as water temperature and water quality in the closed culture cabin 107.

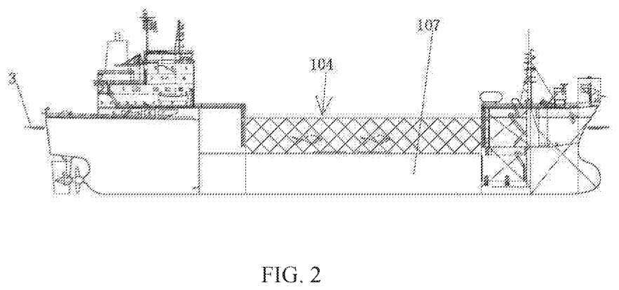

As shown in FIG. 2, an onboard open cage culture mode is set as a second working condition. After reaching a target sea area, the hull 1 is at the position of the first water level 3. The hatch covers 106 are all closed so that the closed culture cabin 107 and the open culture cabin 104 are isolated from each other. At this time, only the open culture cabin 104 is used for culture. The water in the internal space of the cage 105 exchanges freely with sea water to satisfy the needs of fish growth.

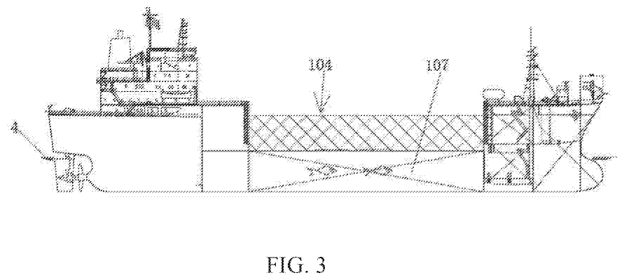

As shown in FIG. 3, an onboard closed cabin culture mode is set as a third working condition. After reaching a target sea area, the hull 1 discharges the ballast water to float to the position of the second water level 4. The hatch covers 106 are all closed, so that the closed culture cabin 107 and the open culture cabin 104 are isolated from each other. At this time, only the closed culture cabin 107 is used for culture. The water pump 110 is used to pump water into the closed culture cabin 107, and the overflow pipe 111 is used to discharge water outside, so as to achieve the purpose of regulating key culture factors such as water temperature and water quality in the closed culture cabin 107.

When it is necessary to transfer under the first and second working conditions, the hatch cover 106 is opened first to make sure that the closed culture cabin 107 and the open culture cabin 104 communicate with each other. Then, when the hull 1 floats, all the culture species of the open culture cabin 104 are confined to the closed culture cabin 107. After that, all the hatch covers 106 are closed, and the water pump 110 and the oxygen supply device 5 are used to guarantee the aquatic water quality in the closed culture cabin 107 according to the requirements of the culture environment. When the hull 1 floats to a draught allowed for navigation, the propulsion system 2 is turned on to autonomously navigate the platform to the next target culture area.

When it is necessary to transfer under the third working condition, all the hatch covers 106 are closed, and the water pump 110 and the oxygen supply device 5 are used to guarantee the aquatic water quality in the closed culture cabin 107 according to the requirements of the culture environment. When the hull 1 floats to a draught allowed for navigation, the propulsion system 2 is turned on to autonomously navigate the platform to the next target culture area.

The hull 1 is usually provided with a conventional auxiliary cabin 103 for storing feed for culture and a fish pump of a catching device.

The above described are merely preferred examples of the present invention. It should be noted that various changes and improvements can be made by those of ordinary skill in the art based on the examples without departing from the concept of the present invention, but these changes and improvements should fall within the protection scope of the present invention.

What is claimed is:

1. A movable aquaculture platform suitable for offshore onboard cabin culture and open culture, comprising a hull (1) with a propulsion system (2) and an onboard control system (7), wherein a recess (102) recessed downwards based on a plane of a main deck (101) is provided between the front and rear of the hull (1); both sides of the recess (102) are formed into an open structure corresponding to double sides of the hull (1); the recess (102) is provided with a closed cage (105) having a net structure; the cage (105) and the recess (102) together constitute an open culture cabin (104); an internal space of the cage (105) is used for culture; the hull (1) is provided with a closed culture cabin (107) below the recess (102).

2. The movable aquaculture platform suitable for offshore onboard cabin culture and open culture according to claim 1, wherein at least one upper hatch (107a) facing the internal space of the cage (105) is provided on an upper side of the closed culture cabin (107); each upper hatch (107a) is provided with a movable hatch cover (106) for opening and closing; when the hatch cover (106) is opened, an internal chamber of the closed culture cabin (107) communicates with the internal space of the cage (105) through the upper hatch (107a).

3. The movable aquaculture platform suitable for offshore onboard cabin culture and open culture according to claim 1, wherein the closed culture cabin (107) is provided with at least one water inlet pipe (108); one end of the water inlet pipe (108) communicates with external water, and the other end of the water inlet pipe (108) communicates with the internal chamber of the closed culture cabin (107); the water inlet pipe (108) is provided with an inlet side remote valve (109) for opening and closing; the water inlet pipe (108) is provided with a water pump (110) for transporting external water to the internal chamber of the closed culture cabin (107); the inlet side remote valve (109) and the water pump (110) are controlled by the onboard control system (7).

4. The movable aquaculture platform suitable for offshore onboard cabin culture and open culture according to claim 3, wherein the closed culture cabin (107) is provided with at least one overflow pipe (111); an inlet end of the overflow pipe (111) communicates with the internal chamber of the closed culture cabin (107), and an outlet end of the overflow pipe (111) is located outside the closed culture cabin (107); the overflow pipe (111) is provided with an overflow remote valve (112) for opening and closing, and the overflow remote valve (112) is controlled by the onboard control system (7).

5. The movable aquaculture platform suitable for offshore onboard cabin culture and open culture according to claim 1, wherein the hull (1) is provided with an oxygen supply device (5) controlled by the onboard control system (7); an outlet of the oxygen supply device (5) communicates with the internal chamber of the closed culture cabin (107) through an oxygen supply line (6).

6. The movable aquaculture platform suitable for offshore onboard cabin culture and open culture according to claim 4, wherein a relative water level above the open culture cabin (104) and below an upper side of the cage (105) is a first water level (3), and a relative water level below the upper side of the closed culture cabin (107) is a second water level (4); the outlet end of the overflow pipe (111) is higher than the second water level (4) and lower than the first water level (3).
